(19) United States
(12) Patent Application Publication
(10) Pub. No.: US 2009/0196327 A1
(43) Pub. Date: Aug. 6, 2009

(54) Sensor Connection Lead with Reduced Heat Conduction

(75) Inventors: Magnus Gmür, Bütschwil (CH); Jiri Holoubek, Wattwil (CH); Jiri Polak, Neu St. Johann (CH)

Correspondence Address: BACON & THOMAS, PLLC, 625 SLATERS LANE, FOURTH FLOOR, ALEXANDRIA, VA, 22314-1176, US

(73) Assignee: Innovative Sensor Technology, Wattwil (CH)

(21) Appl. No.: 11/883,338

(22) PCT Filed: Apr. 25, 2005
(86) PCT No.: PCT/CH05/00230

§ 371 Date: Jun. 3, 2008

(30) Foreign Application Priority Data
Feb. 10, 2005 (CH) 222/05

(51) Int. Cl. G01K 7/18; H01B 13/00

(52) U.S. Cl. 374/185; 216/14; 374/E07.021

(57) ABSTRACT

A sensor for measuring physical parameters, wherein a sensor element, arranged on a substrate platelet, may be connected to an evaluating circuit by means of connection leads. The connection leads are a planar piece made from sheet metal. connection leads have a plurality of perforations between connection areas The perforations being preferably triangular, with adjacent triangles rotated relative to each other by 180 degrees, such that the connection lead is embodied as a planar lattice of longitudinal legs and inclined, transverse legs. The thermal conductance through the connection between sensor and evaluating circuit is reduced by means of said perforations. The response characteristics and precision of the sensor are hence improved.

The invention relates to a sensor as defined in the preamble of claim 1, as well as to a method for manufacturing such sensors, as defined in the preamble of claim 6.

Such sensors serve, for example, for measuring temperature. A layer resistor represents the active sensor element. The layer resistor is located on a substrate-platelet, which is made, for example, of ceramic. Such temperature sensors are known, for example, from U.S. Pat. No. 5,202,665 and DE-C1 100 20 932.

EP-B1 1 047 923 shows a sensor component, in the case of which a metal film is applied to a ceramic support. Connection wires are connected with contact areas of the metal film.

A method for cost-effective manufacture of such sensor components is presented in EP-A2 1 124 238.

Known are also capacitive moisture sensors, where the electrodes and associated connection points are arranged on a substrate. Such a sensor is known from WO-A1 00/25120.

Sensors of the aforementioned kind serve for measuring a physical variable, thus, for example, the temperature or humidity of a gas. Under the influence of the physical variable, the sensor changes its properties. In the case of temperature sensors, this can be, for example, the electrical resistance of the sensor, while, in the case of moisture sensors, it is the capacitance of the sensor. The measured value of the physical variable is ascertained from the property change of the sensor by means of an evaluating circuit. The sensor is, in such case, connected by at least two electrical connections with the evaluating circuit. Here, there is then the problem, that the measured value can be degraded by this connection with the evaluating circuit.

In the case of a temperature sensor, the degradation of the measured value can by caused by the fact that heat can be conducted away from the sensor and into the evaluating circuit. When low temperatures, for example below freezing, are to be measured with the temperature sensor, conversely, heat can move from the evaluating circuit to the sensor and, in this way, degrade the measured value.

In the case of sensors for other physical variables, similar problems can arise. In a humidity sensor, a temperature change at the sensor relative to the temperature of the gas, whose humidity is to be measured, likewise leads to an erroneous measured value for the humidity.

An object of the invention is to avoid the described problems by reducing heat conduction via the connection between sensor and evaluating circuit, in order, in this way, to improve both response and accuracy.

Such object is achieved according to the invention by the features of claim 1. Advantageous further developments of the invention result from the dependent claims.

An example of an embodiment of the invention will now be explained in more detail on the basis of the drawing, the figures of which show as follows:

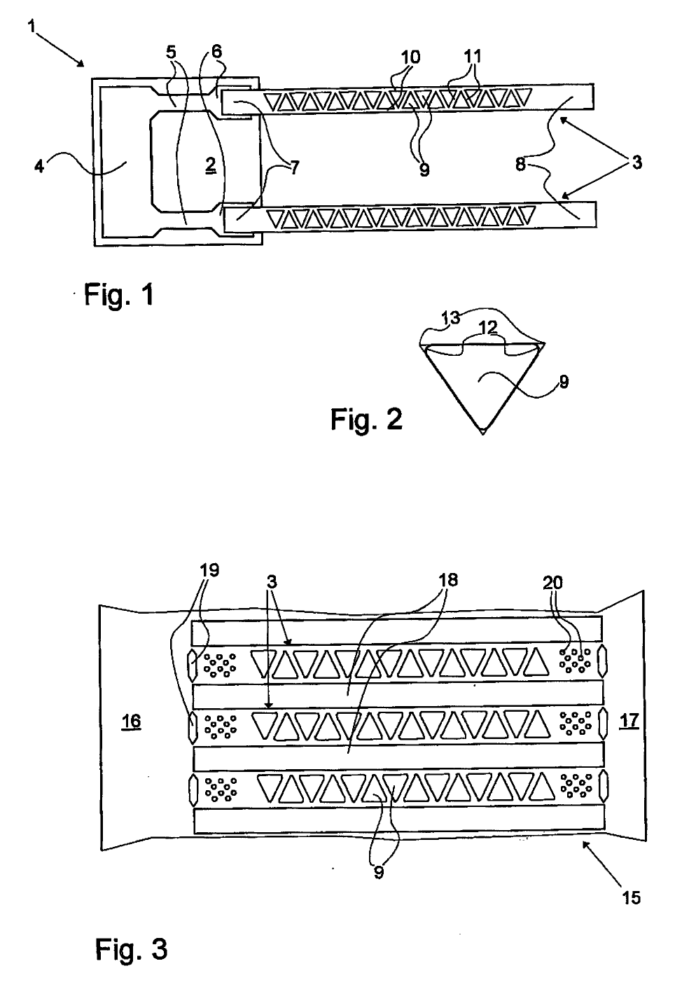

FIG. 1 a sensor;

FIG. 2 a perforation in a connection lead; and

FIG. 3 a section through a connection lead precursor.

FIG. 1 shows a sensor 1 composed of a substrate platelet 2 and two connection leads 3. On the substrate platelet 2, a sensor element 4 is arranged, which is indicated here only schematically. Depending on the physical variable to be measured, this sensor element will have a construction appropriate for that variable. If the physical variable to be measured is a temperature, then the sensor element 4 is, for example, a thin layer of a material having a high electrical resistance. As known, this thin layer can follow a meandering path. Conductive traces 5 extend from the sensor element to the connection points 6, with which the connection leads are electrically and mechanically securely connected, for example by way of resistance welding. The connection leads 3 are produced from metal sheet by etching, stamping or cutting and thus themselves have a sheet-like character. Each has two ends providing connection areas 7, 8. A first connection area 7 is, in such case, connected with a connection point 6, while a connection area 8 on the other end of the connection lead 3 serves for connecting the sensor with an evaluating circuit (not shown). Because the connection areas 8 are flat, they are especially suited for populating using SMD technology.

According to the invention, connection leads 3 have between the connection areas 7 and 8 a plurality of perforations 9, which are preferably triangular in shape. Neighboring triangular perforations 9 are rotated 180-degrees with respect to one another. In the region of the perforations 9, the connection leads 3 thus form a planar lattice of longitudinal legs 10 and inclined, transverse legs 11. Characteristic of this lattice is a high mechanical load carrying ability, due to its bending stiffness. At the same time, however, the cross section responsible for heat conduction is very markedly reduced. The markedly lessened heat conduction from sensor element to evaluating circuit, and vice versa, means improved response sensitivity of the sensor element 4 and, therewith, improved accuracy of measurement. Reduction of the cross section responsible for heat conduction is also achievable by other forms of perforations 9, for example by round, hexagonal or four-sided perforations 9; however, the illustrated triangular form is most advantageous from the point of view of bending stiffness.

FIG. 2 shows an enlarged view of a perforation 9. The perforation 9 is triangular but has rounded fillets 12 at its corners 13. The basic form of the triangles can be equilateral or isosceles. The fillets 12 reduce the notch effect and so reduce the danger of fracture under mechanical loading.

FIG. 3 shows part of a connection-lead precursor 15. It is composed of a large number of connection leads 3 with perforations 9, as well as a first interconnection strip 16 and a second interconnection strip 17. Between the individual connection leads 3 are interstices 18. At the transitions between the individual connection leads 3 and the connecting strips 16, 17 are placed, advantageously, gaps 19, which are produced, as the perforations 9 and interstices 18, by etching, stamping or cutting. The cutting can, in such case, in view of the small size of such sensors, be done advantageously by means of laser beam. The gaps 19 are, advantageously, sharply pointed at both ends, for, here, the notch effect is desired, in order to create, in simple manner, intentional fracture locations between the individual connection leads and the connection strips 16, 17, as described in EP 1 124 238 A2. This is advantageous, because, for separating the individual sensors 1, no separating tool is required, for, due to the gaps 19 sharply pointed both ends, removal of the connecting strips 16, 17 can be effected alone by easy bending back and forth.

Advantageously, the connection areas 7 and/or the connection areas 8 (FIG. 1) contain penetrations, namely, for example, circular holes 20. If the connecting surfaces 7 are connected with the connection points 6 (FIG. 1) by resistance welding, then a locally high current flow occurs during the welding because of these holes 20, this having a positive effect on the quality of the welded connection. The connection areas 8 are most often connected with contacts at the evaluating circuit. If this connection is done, for example, by soldering, then the holes 20 fill at least partly with solder, this likewise providing an improvement of the quality of the connection.

The perforations 9 in the connection leads 3 offer yet another advantage when the sensor 1 including its leads are partially potted in plastic. The potting compound then flows into the perforations 9, in order to form a traversing connection, from above the connection leads 3 to below them.

The invention can also be advantageously applied in the case of sensors which simultaneously measure a plurality of physical variables.

1-6. (canceled)

7. A sensor for measurement of physical variables, comprising:
a substrate platelet;
a sensor element arranged on said substrate-platelet; and
an evaluating circuit, said sensor element being connectable with said evaluating circuit by means of connection leads, wherein:
said connection leads have spaced connection areas; and
said connection lead each comprise a sheet-like piece produced from a metal sheet with a plurality of perforations arranged in the connection leads between connection areas.

8. The sensor as claimed in claim 7, wherein:
said perforations are triangular; and
neighboring triangles are rotated 180-degrees relative to one another, so that said connection lead is embodied as a planar lattice of longitudinal legs and inclined, transverse legs.

9. The sensor as claimed in claim 8, wherein:
the corners of said triangles contain rounded fillets.

10. The sensor as claimed in claim 7, wherein:
the connection areas contain penetrations.

11. The sensor as claimed in claim 10, wherein:
said penetrations in the connection areas are circular holes.

12. A method for manufacturing a sensor comprising:
claim 7, comprising the steps of:
producing a connection lead precursor from a metal sheet in one step, in the one step; and
forming by one of etching, stamping and cutting interstices, perforations and gaps, and preferably also holes
